(19) United States
(12) Patent Application Publication
(10) Pub. No.: US 2007/0236399 A1
(43) Pub. Date: Oct. 11, 2007

(54) Antenna device with antenna element matched by resonance circuit

(76) Inventors: Yu-Chiang Cheng, Taipei City (TW); Ping-Cheng Chang, Chaozhou Town (TW); Cheng-Zing Chou, Xinying City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/474,935

(22) Filed: Jun. 27, 2006

(30) Foreign Application Priority Data
Apr. 7, 2006 (TW) 95112537

(51) Int. Cl. H01Q 9/00; H01Q 1/24

(52) U.S. Cl. 343/745; 343/702

(57) ABSTRACT

Disclosed is an antenna device with an antenna element with a predetermined shorten length, and a resonance circuit coupled to the antenna element, having a predetermined resonance frequency for matching the shorten length of the antenna element to adaptively make the antenna element in response to and transceive a wireless signal with a predetermined frequency.

### FIELD OF THE INVENTION

The present invention relates to an antenna device used in wireless technology, and in particular to an antenna device with an antenna element matched by a resonance circuit.

### BACKGROUND OF THE INVENTION

It is well known that an antenna is the key element to transmit/receive (transceive) microwaves in wireless technology such as wireless communication and wireless data transfer, where the antenna transforms electrical currents generated by a transmitter into microwaves and transmits the microwaves in free space. The antenna also captures microwaves and transforms them into electrical currents, which are then processed by a receiver.

Further, electromagnetic pulse, which is generated by the presence of electric currents in an antenna, radiates in to free space from the site of an antenna by the speed of light. The presence of the antenna provides a media for the alteration of the electromagnetic field, while the length of the antenna determines the specific electromagnetic pulse the antenna responds to. Only the antenna with the specific length, therefore, is capable of responding to a specific wireless signal with a specific frequency; hence made possible the transceiving of such wireless signal.

Please refer to FIG. 1 that is a perspective view of an antenna of conventional use arranged inside an electronic device. As shown in the figure, a casing 1 of an electronic device 100 is provided with an antenna element 2 and an antenna signal feeding line 3, which is electrically connected to a signal feeding end 21 of the antenna element 2 and the antenna transceiving module (not shown in the figure) of the electronic device 100 for feeding the wireless signal transceived by the antenna element 2.

As shown in FIG. 2, which is a response curve of the antenna of conventional use, the vertical axis represents the intensity S of the wireless signal transceived by the antenna element 2, and the horizontal axis represents the frequency f of the wireless signal that the antenna element 2 responds to. From the response curve A, the antenna element 2 with a specific length responds to a wireless signal with the frequency f1 is obvious and easily understood, and only antennas with the specific length respond to such wireless signal with the frequency f1; hence capable of transceiving the wireless signal.

The resistance of the antenna element 2 reaches its minimum when the antenna element 2 responds and resonates to the wireless signal with the frequency f1; therefore, the intensity of the wireless signal reaches its maximum and optimizes the transceiving of such wireless signal. While the antenna element 2, with no doubt, is still capable of responding and resonating with a wireless signal with the frequency f, the resistance of the antenna element 2, however, becomes greater. As a consequence, the intensity of the wireless signal is lesser as shown in the figure; thus weakens the capability of the antenna element 2 of the transceiving of such wireless signal.

Please refer to FIG. 3 that shows the relation between the length of the antenna and its resonance frequency. As shown in the figure, the vertical axis represents the length L of the antenna element 2, and the horizontal axis represents the frequency f of the wireless signal that the antenna element 2 responds to.

It is also obvious from the curve B that the resonance frequency fA of an antenna element with a length LA is greater than the resonance frequency fB of an antenna element with a length LB, which is greater than the length LA, and even greater than the resonance frequency fC of an antenna element with a length LC, which is even greater than the length LB.

In a nutshell, the greater the length of the antenna element, the lesser the resonance frequency the antenna element responds. Therefore, an antenna element with a length corresponding to a wireless signal with a specific frequency must be utilized when an electronic device with the antenna element desires to transceive the wireless signal with such frequency.

The length of the electronic device, however, restricts the length of the antenna element as well. Due to the strict demand of the length and size of the electronic device have nowadays use; there is not enough arrangement space for antenna element with longer length.

Besides, since the antenna element of the electronic device of conventional use is formed with fixed length, the antenna element is only capable of transceiving the wireless signal with the specific frequency. When the electronic device desires to transceive a plurality of wireless signals with different frequencies, arrangement of a plurality of antenna elements with the lengths corresponding to the frequencies of the wireless signals is unavoidable.

### SUMMARY OF THE INVENTION

The primary object of the present invention, therefore, is to provide an antenna device with an antenna element matched by a resonance circuit to decrease the length of the antenna element. In addition, another object of the present invention is to provide an antenna element matched by a resonance circuit to transceive a plurality of wireless signals with predetermined frequencies.

To realize the above objects, the present invention installs an antenna element with a predetermined shorten length and having a signal feeding end, a resonance circuit with an antenna connection end connected to the signal feeding end of the antenna element and an antenna signal feeding line connection end, having a predetermined resonance frequency for matching the shorten length of the antenna element to adaptively make the antenna element in response to and transceive a wireless signal with a predetermined frequency; and an antenna signal feeding line coupling to the antenna signal feeding line connection end of the resonance circuit for feeding the wireless signal transceived by the antenna element.

In comparison with the conventional technologies, the present invention enables an antenna device with an antenna element matched by a resonance circuit to decrease the length of the antenna element. Besides, the antenna element matched by a resonance circuit to transceive a plurality of wireless signals with predetermined frequencies is also made possible.

These and other objects, features and advantages of the invention will be apparent to those skilled in the art, from a reading of the following brief description of the drawings, the detailed description of the preferred embodiment, and the appended claims.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of an antenna of conventional use arranged inside an electronic device;

FIG. 2 is a response curve of the antenna of conventional use;

FIG. 3 shows the relation between the length of the antenna and its resonance frequency;

FIG. 4 is a perspective view of an antenna device with a resonance circuit for matching the length of an antenna element in accordance with a preferred embodiment of the present invention;

FIG. 5 shows the antenna device with the resonance circuit for matching the length of the antenna element in accordance with the preferred embodiment of the present invention;

FIG. 6 shows an equivalent resonance circuit; and

FIG. 7 is a response curve of the antenna device with the resonance circuit for matching the length of the antenna element in accordance with the preferred embodiment of the present invention.

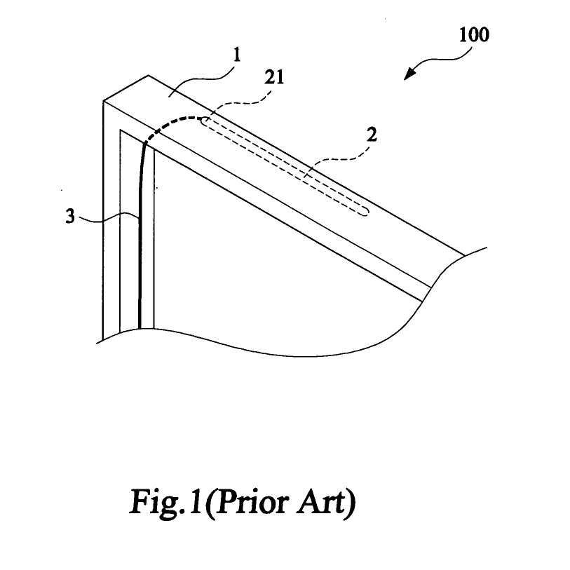

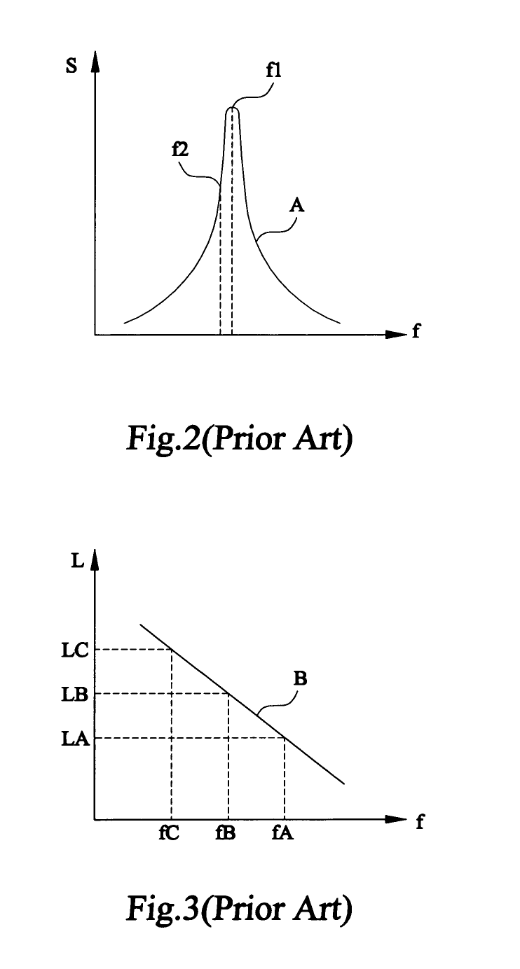

### DETAILED DESCRIPTION OF THE PREFERRED EMBODIMENTS

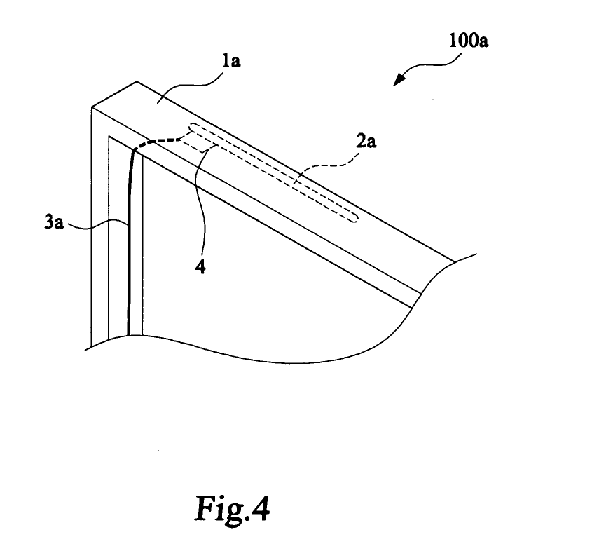

With reference to the drawings and in particular to FIG. 4, which is a perspective view of an antenna device with a resonance circuit for matching the length of an antenna element in accordance with a preferred embodiment of the present invention, a casing la of an electronic device 100a is provided with an antenna element 2a, an antenna signal feeding line 3a and a resonance circuit 4.

The antenna signal feeding line 3a is electrically connected to the resonance circuit 4 and an antenna transceiving module (not shown in figure) of the electronic device 100a, while the resonance circuit 4 is electrically connected to the antenna element 2a for feeding a wireless signal transceived by the antenna element.

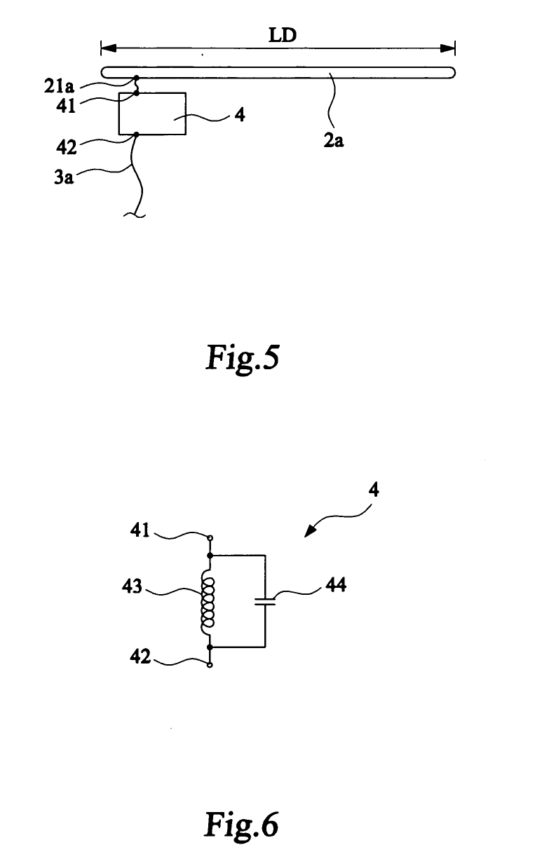

Please refer to FIG. 5 that shows the antenna device with the resonance circuit for matching the length of the antenna element in accordance with the preferred embodiment of the present invention. As shown in the figure, the antenna element 2a is provided with a signal feeding end 21a, while the resonance circuit 4 is provided with an antenna connection end 41 and an antenna signal feeding line connection end 42, wherein the antenna connection end 41 is capable of electrically connecting to the signal feeding end 21a, and the antenna signal feeding line connection end 42 is capable of electrically connecting to the antenna signal feeding line 3a.

The resonance circuit 4 is provided with a predetermined resonance frequency. While the antenna element 2a transceives the wireless signal, the resonance circuit 4 is capable of matching and responding the antenna element 2a with a predetermined shorten length LD to the frequency of the wireless signal.

As shown in FIG. 6, which shows an equivalent resonance circuit, the antenna connection end 41 of the resonance circuit 4 is coupled to the signal feeding end 21a of the antenna element 2, and the antenna signal feeding line connection end 42 of the resonance circuit 4 is coupled to the antenna signal feeding line 3a. In addition, the resonance circuit 4 is a parallel connection of an inductance 43 and a capacitor 44. The resonance frequency of the resonance circuit 4 is the reciprocal of the 2π-multiplied root of the product of the inductance of the inductance 43 and the capacitance of the capacitor 44.

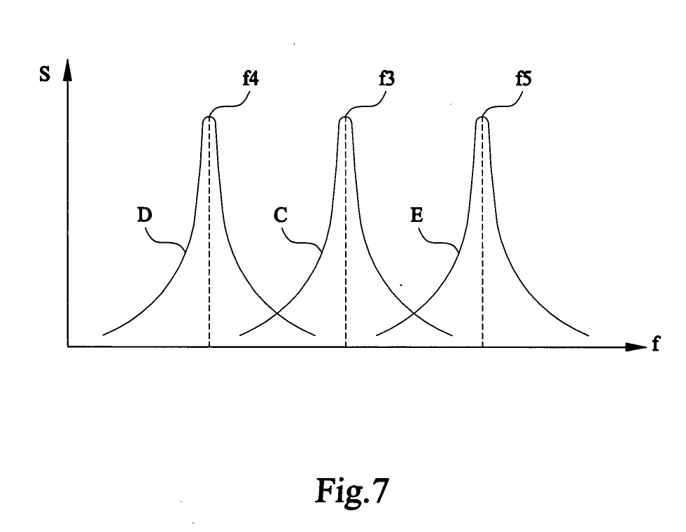

Please refer to FIG. 7, which is a response curve of the antenna device with the resonance circuit for matching the length of the antenna element in accordance with the preferred embodiment of the present invention. As shown in the figure, the vertical axis represents the intensity S of the wireless signal transceived by the antenna element 2a, and the horizontal axis represents the frequency f of the wireless signal that the antenna element 2a responds to. The response curves C, D and E represent, respectively, the response curve of the antenna element 2a of the initial state and the response curves of the antenna element 2a after the matching of the resonance circuit 4.

It is obvious from the response curve C that the antenna element 2a responds to the wireless signal with the frequency f3; hence the intensity of the wireless signal transceived by the antenna element 2a reaches the maximum. On the other hand, it is also obvious from the response curve D that the antenna element 2a responds to the wireless signal with the frequency f4 after the matching of the resonance circuit 4 without changing the length of the antenna element 2a (i.e. to increase its length), and the transceiving of the wireless signal with the frequency f4 is made possible.

Moreover, from the response curve E, which shows the response curve after the antenna element 2a is matched by another resonance circuit with a predetermined resonance frequency, the antenna element 2a responds to the wireless signal with the frequency f5 without changing the length of the antenna element 2a (i.e. to decrease its length in this case); hence made possible the transcieving of the wireless signal with the frequency f5.

While the invention has been described in connection with what is presently considered to the most practical and preferred embodiments, it is to be understood that the invention is not to be limited to the disclosed embodiments, but on the contrary, is intended to cover various modifications and equivalent arrangement included within the spirit and scope of the appended claims.

What is claimed is:

1. An antenna device, comprising:
an antenna element with a predetermined shorten length and having a signal feeding end;
a resonance circuit with an antenna connection end connected to the signal feeding end of the antenna element and an antenna signal feeding line connection end, having a predetermined resonance frequency for matching the shorten length of the antenna element to adaptively make the antenna element in response to and transceive a wireless signal with a predetermined frequency; and
an antenna signal feeding line coupling to the antenna signal feeding line connection end of the resonance circuit for feeding the wireless signal transceived by the antenna element.

2. The antenna device as claimed in claim 1, wherein the antenna element is arranged inside an electronic device.

3. The antenna device as claimed in claim 2, wherein the electronic device is a personal computer.

4. The antenna device as claimed in claim 1, wherein the resonance circuit comprises a parallel connection of an inductance and a capacitor.

5. An antenna device, comprising:
an antenna element with a predetermined shorten length; and
a resonance circuit coupled to the antenna element, having a predetermined resonance frequency for matching the shorten length of the antenna element to adaptively make the antenna element in response to and transceive a wireless signal with a predetermined frequency.

6. The antenna device as claimed in claim 5, wherein the antenna element is arranged inside an electronic device.

7. The antenna device as claimed in claim 6, wherein the electronic device is a personal computer.

8. The antenna device as claimed in claim 5, wherein the resonance circuit comprises a parallel connection of an inductance and a capacitor.
